(19) United States
(12) Patent Application Publication
(10) Pub. No.: US 2023/0324232 A1
(43) Pub. Date: Oct. 12, 2023

(54) THERMOCOUPLE SENSOR AND PRODUCTION METHOD THEREFOR

(71) Applicant: Chao MA, Hubei (CN)

(72) Inventor: Chao MA, Hubei (CN)

(21) Appl. No.: 18/076,413

(22) Filed: Dec. 7, 2022

(30) Foreign Application Priority Data
Apr. 12, 2022 (CN) 202210380621.1
Jun. 16, 2022 (CN) 202210681385.7

(51) Int. Cl. G01K 7/04

(52) U.S. Cl. CPC G01K 7/04; B23K 26/21

(57) ABSTRACT

A thermocouple sensor and a production method therefor, wherein the thermocouple sensor has a thermocouple body and a stainless steel pipe, wiring metal ends are arranged at both ends of the thermocouple body, there is an opening at one end of the stainless steel pipe and a pore at another end, the thermocouple body inserts into the stainless steel pipe from the opening, and one of the wiring metal ends passes through the pore and is welded with the stainless steel pipe at the pore. The stainless steel pipe is directly changed from a heat transfer component into a heat sensing component, so that after the stainless steel pipe is in contact with the heat, the heat is not required to be transferred to a heat conducting medium and subsequently to the thermocouple.

### BACKGROUND OF THE INVENTION

The present invention relates to a thermocouple sensor and a production method therefor.

At present, during the production of thermocouple type temperature sensors in the market, heat conducting glue is generally required to be added between a stainless steel pipe and a thermocouple to serve as a heat conducting medium. In such a product, when the temperature sensor measures and senses the temperature, the heat needs to be transmitted to a heat conducting glue or other types of heat conducting media through stainless steel, and then the heat is transmitted to a thermocouple wire. In the above process, the temperature sensing process or the temperature stabilizing process of the thermocouple is generally within 3-5 seconds, the temperature response is delayed, and the user experience is poor.

### BRIEF SUMMARY OF THE INVENTION

In order to overcome the defects in the above technology, the present invention provides a thermocouple sensor, which comprises a thermocouple body and a stainless steel pipe, wherein wiring metal ends are arranged at both ends of the thermocouple body respectively, an opening is formed at one end of the stainless steel pipe, and a pore is formed at another end of the stainless steel pipe; the thermocouple body inserts into the stainless steel pipe from the opening of the stainless steel pipe, and one of the wiring metal ends passes through the pore, and the wiring metal end passing through the pore is welded with the stainless steel pipe at the pore.

Furthermore, a diameter of the pore is 0.3-0.8 mm.

Furthermore, the wiring metal end passing through the pore and the stainless steel pipe are welded together by laser welding or hot melt welding.

Furthermore, the thermocouple body is made of nickel.

The present invention also provides a production method for a thermocouple sensor, wherein the thermocouple sensor comprises a thermocouple body and a stainless steel pipe, wherein wiring metal ends are arranged at both ends of the thermocouple body respectively, an opening is formed at one end of the stainless steel pipe and a pore is formed at another end of the stainless steel pipe; the production method comprises the following steps:

S1, inserting the thermocouple body into the stainless steel pipe from the opening of the stainless steel pipe, and passing one of the wiring metal ends through the pore; and

S2, welding the wiring metal end passing through the pore and the stainless steel pipe together at the pore.

After step S1 and before step S2, the following step is performed:

tightening the pore of the stainless steel pipe by narrowing the pore towards a center thereof so as to compact and fix the wiring metal end passing through the pore and the stainless steel pipe together.

After step S2, the following step is performed:

polishing and grinding a welding position of the stainless steel pipe.

The present invention has the following beneficial effects: In the present invention, the stainless steel pipe and the thermocouple body are fused into a one whole piece by laser welding or hot melt welding, so that the problem of heat conduction between the thermocouple body and the stainless steel pipe can be thoroughly solved, and the heat dissipation in the conduction process is completely avoided; moreover, during laser welding or hot melt welding process, the pore cannot be too large, therefore, the diameter of the pore is preferably 0.3-0.8 mm, so that thermocouple wires can be ensured to just pass through the aperture of the pore of the stainless steel pipe, so that the stainless steel pipe and the thermocouple wires can be ensured to be fused into a one whole piece in the laser welding or hot melt welding process, and air tightness is ensured; on the other hand, it has to be ensured that the instantaneous temperature of the laser welding or the hot melt welding can reach 1450° C., such that the laser welding or the hot melt welding is rapid and efficient within the effective fusion period of the thermocouple wire and the stainless steel pipe, and thus ensuring that an insulating layer of the thermocouple wires will not age during the welding process.

### BRIEF DESCRIPTION OF THE DRAWINGS

FIG. 1 is a schematic structural diagram of a thermocouple body according to an embodiment of the present invention.

FIG. 2 is a schematic structural diagram of a stainless steel pipe according to an embodiment of the present invention.

FIG. 3 is a schematic structural diagram of a thermocouple sensor according to an embodiment of the present invention.

FIG. 4 is a schematic structural diagram of the wiring metal end passing through the pore and the stainless steel pipe welded together at the pore after the pore is tightened and narrowed according to an embodiment of the present invention.

FIG. 5 is an enlarged view of a portion A in FIG. 4.

### DETAILED DESCRIPTION OF THE INVENTION

The present invention is further illustrated with reference to the following embodiments which are only some embodiments of the present invention, and these embodiments are only for illustrating the present invention and do not limit the scope of the present invention.

Any flowcharts shown in the figures are illustrative only and do not necessarily include all of the contents and operations/steps, nor do they necessarily be performed in the order described. For example, some operations/steps may be further divided, combined or partially combined, so that the actual execution order may be changed according to the actual situation.

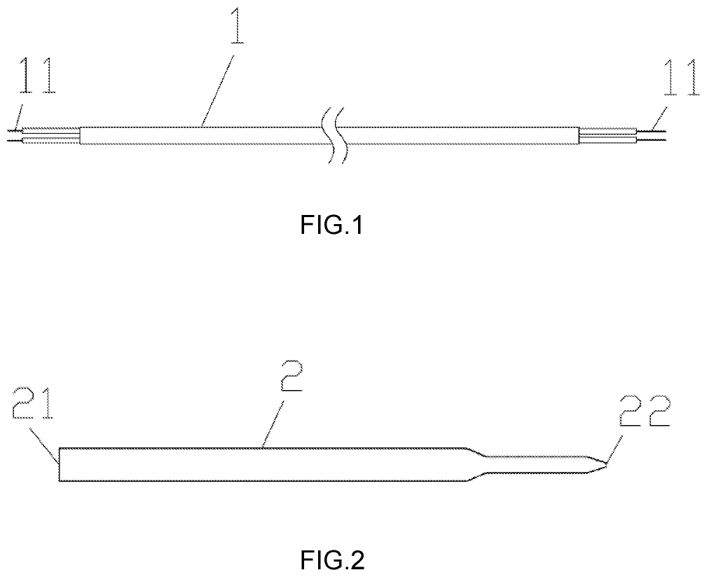

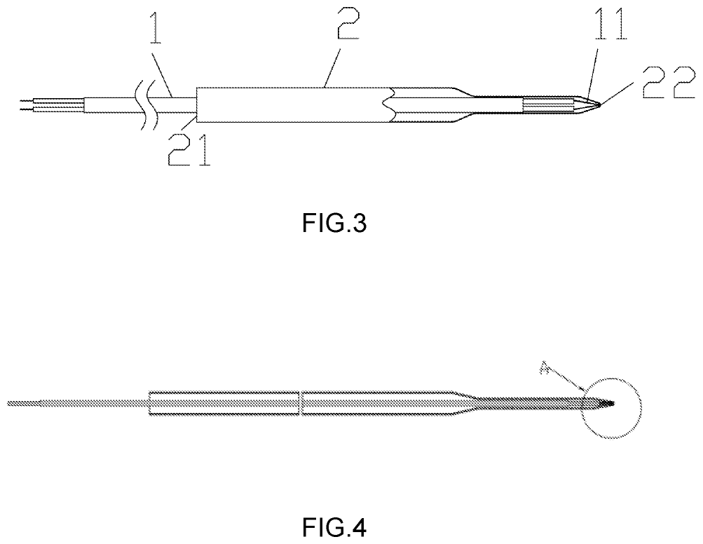

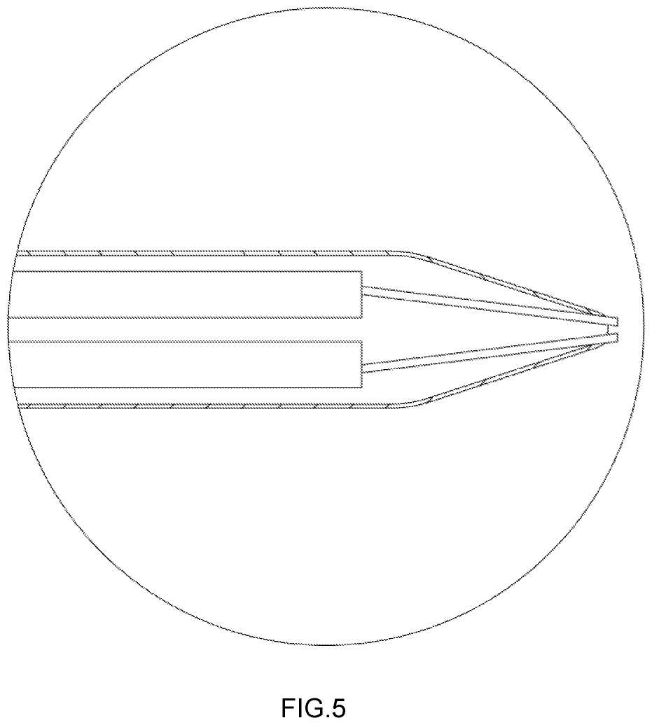

Referring to FIGS. 1 to 5, the present invention relates to a thermocouple sensor, which comprises a thermocouple body 1 and a stainless steel pipe 2, wherein wiring metal ends 11 are arranged at both ends of the thermocouple body 1 respectively, an opening 21 is formed at one end of the stainless steel pipe 2 and a pore 22 is formed at another end of the stainless steel pipe 2, the thermocouple body 1 inserts into the stainless steel pipe 2 from the opening 21 of the stainless steel pipe 2, and one of the wiring metal ends 11 passes through the pore 22, and the wiring metal end 11 passing through the pore 22 is welded with the stainless steel pipe 2 at the pore 22.

In a further aspect of the present invention, a diameter of the pore is 0.3-0.8 mm.

In a further aspect of the present invention, the wiring metal end 11 passing through the pore 22 and the stainless steel pipe 2 are welded together by laser welding or hot melt welding.

A production method for the above thermocouple sensor comprises the following steps:

S1, inserting the thermocouple body 1 into the stainless steel pipe 2 from the opening 21 of the stainless steel pipe 2, and passing one of the wiring metal ends 11 through the pore 22; and

S2, welding the wiring metal end 11 passing through the pore 22 and the stainless steel pipe 2 together at the pore 22.

In the present invention, the stainless steel pipe 2 and the thermocouple body 1 are fused into a one whole piece by laser welding, so that the problem of heat conduction between the thermocouple body 1 and the stainless steel pipe 2 can be thoroughly solved, and the heat dissipation in the conduction process is completely avoided; moreover, during laser welding or hot melt welding process, the pore cannot be too large, therefore, the diameter of the pore is preferably 0.3-0.8 mm, so that thermocouple wires can be ensured to just pass through the aperture of the pore of the stainless steel pipe, so that the stainless steel pipe and the thermocouple wires can be ensured to be fused into a one whole piece in the laser welding process, and the air tightness is ensured; on the other hand, it has to be ensured that the instantaneous temperature of the laser welding or the hot melt welding can reach 1450° C., such that the laser welding or the hot melt welding is rapid and efficient within the effective fusion period of the thermocouple wire and the stainless steel pipe, and thus ensuring that an insulating layer of the thermocouple wires will not age in the welding process. The present invention adopts a welding process wherein the instantaneous welding temperature can reach 1450° C. or above, so that the hot melting temperature can reach the melting point of the thermocouple wire and the stainless steel pipe instantaneously, and the thermocouple wire and the stainless steel pipe are fused instantaneously, wherein the fusion time is controlled within 2 seconds so as to avoid an insulating rubber at a rear part of the thermocouple wires being affected due to excessively long welding process; the insulating rubber may be made of a poly tetra fluoroethylene (PTFE) material which will not melt or retract at an instantaneous temperature of 260° C. or above reached within 2 seconds.

In a further aspect of the present invention: after S1 and before S2, the following step is performed:

tightening the pore of the stainless steel pipe by narrowing the pore towards its center so as to compact and fix the wiring metal end passing through the pore and the stainless steel pipe together. Before welding, the pore of the stainless steel pipe 2 through which the wiring metal end 11 passes through is tightened and narrowed so as to tightly compact with the wiring metal end 11, so that the pore will not be too large during the welding process. In case where the pore is not tightened and narrowed, a larger pore size will result in long welding time in order to seal the pore by welding, but long welding time may lead to melting of the wiring metal end 11 and thus damage the end product.

In a further aspect of the present invention: after S2, the following step is performed:

polishing and grinding a welding position of the stainless steel pipe. After welding, the welded surface is yellowed and has welded spots, therefore, the surface needs to be polished, and a polishing wheel is used for polishing the surface, so that the thermocouple sensor is not easy to rust and corrode during long-term use such as probing food temperature.

The above are only preferred embodiments of the present invention, and are not intended to limit the present invention. For those skilled in the art, the present invention can be modified and varied. Any modification, equivalent, improvement and the like made without departing from the spirit and principle of the present invention shall fall within the protection scope of the present invention.

What is claimed is:

1. A thermocouple sensor, comprising a thermocouple body and a stainless steel pipe, wherein wiring metal ends are arranged at both ends of the thermocouple body respectively, an opening is formed at one end of the stainless steel pipe, and a pore is formed at another end of the stainless steel pipe; the thermocouple body inserts into the stainless steel pipe from the opening of the stainless steel pipe, and one of the wiring metal ends passes through the pore, and the wiring metal end passing through the pore is welded with the stainless steel pipe at the pore.

2. The thermocouple sensor according to claim 1, wherein a diameter of the pore is 0.3-0.8 mm.

3. The thermocouple sensor according to claim 1, wherein the wiring metal end passing through the pore and the stainless steel pipe are welded together by laser welding or hot melt welding.

4. The thermocouple sensor according to claim 1, wherein the thermocouple body is made of nickel.

5. A production method for a thermocouple sensor, wherein the thermocouple sensor comprises a thermocouple body and a stainless steel pipe, wherein wiring metal ends are arranged at both ends of the thermocouple body respectively, an opening is formed at one end of the stainless steel pipe and a pore is formed at another end of the stainless steel pipe; the production method comprises the following steps:
S1, inserting the thermocouple body into the stainless steel pipe from the opening of the stainless steel pipe, and passing one of the wiring metal ends through the pore; and
S2, welding the wiring metal end passing through the pore and the stainless steel pipe together at the pore.

6. The production method for a thermocouple sensor according to claim 5, wherein after step S1 and before step S2, the following step is performed:
tightening the pore of the stainless steel pipe by narrowing the pore towards a center thereof, so as to compact and fix the wiring metal end passing through the pore and the stainless steel pipe together.

7. The production method for a thermocouple sensor according to claim 5, wherein after step S2, the following step is performed:
polishing and grinding a welding position of the stainless steel pipe.
